(19) United States
(12) Patent Application Publication
(10) Pub. No.: US 2018/0273252 A1
(43) Pub. Date: Sep. 27, 2018

(54) Closing element for containers and method for producing said closing element

(71) Applicant: Brunello Bernasconi, Cadro (CH)

(72) Inventors: Brunello Bernasconi, Cadro (CH); Andrea Barca, Gravesano (CH)

(21) Appl. No.: 15/764,306

(22) PCT Filed: Sep. 28, 2016
(86) PCT No.: PCT/IB2016/001381

§ 371 Date: Mar. 28, 2018

(30) Foreign Application Priority Data
Sep. 28, 2015 (CH) 01403/15
Sep. 28, 2015 (IT) 102015000055995

(51) Int. Cl. B65D 39/00; B32B 7/12; B32B 9/02; B32B 9/04; B32B 27/30; B32B 37/18

(52) U.S. Cl. CPC B65D 39/0058; B32B 7/12; B32B 9/02; B32B 9/045; B32B 27/308; B32B 2435/02; B32B 37/18; B32B 2250/02; B32B 2307/7265; B32B 2307/7242; B32B 2317/02; B32B 27/30

(57) ABSTRACT

The concepts herein relate to a closing element (1) for containers for liquids, in particular bottles. The closing element (1) comprises at least a cork sheet (2) having two opposite main faces (2a, 2b) and at least a layer of insulating material (7), impermeable to liquids and to air and/or gases, coupled to the cork sheet (2). The layer of insulating material (7), at least partly covers at least one of said two main faces (2a, 2b). The cork sheet (2) and the layer of insulating material (7) are rolled so as to define the closing element (1) by an alternated winding of the cork sheet (2) and the layer of insulating material (7), and the layer of insulating material (7) and the alternated winding are configured and predisposed to make the closing element (1) impermeable or to liquids and air and/or gases. The mechanical winding is guaranteed by a partial and spotted gluing of the surfaces, usually only at the external end thereof.

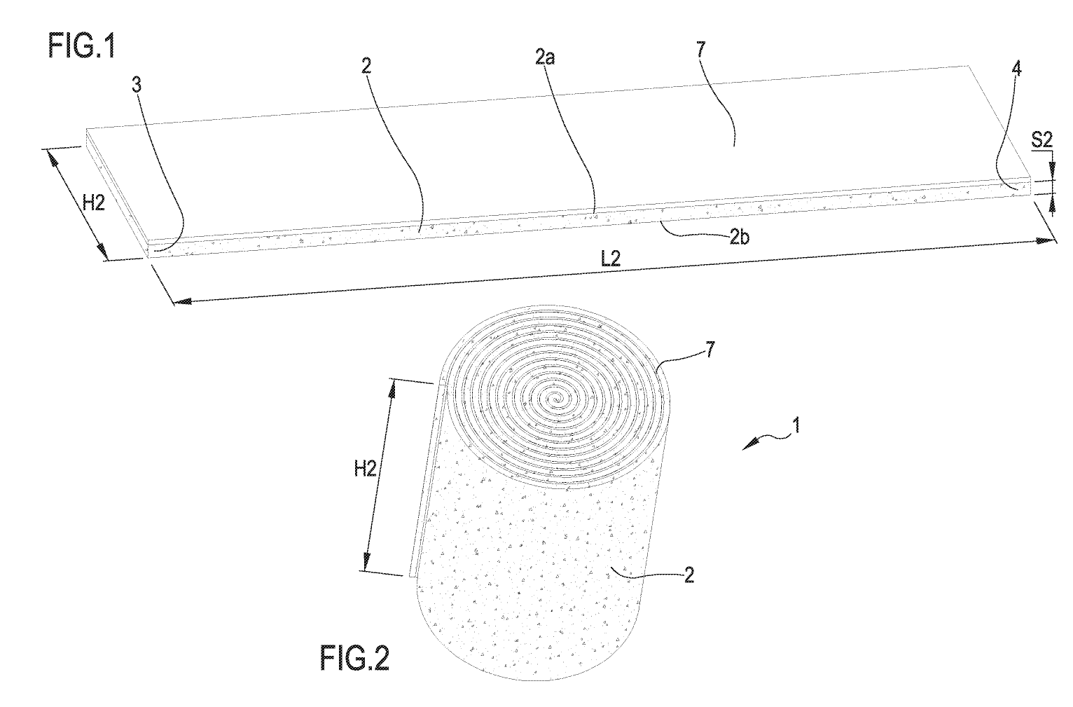

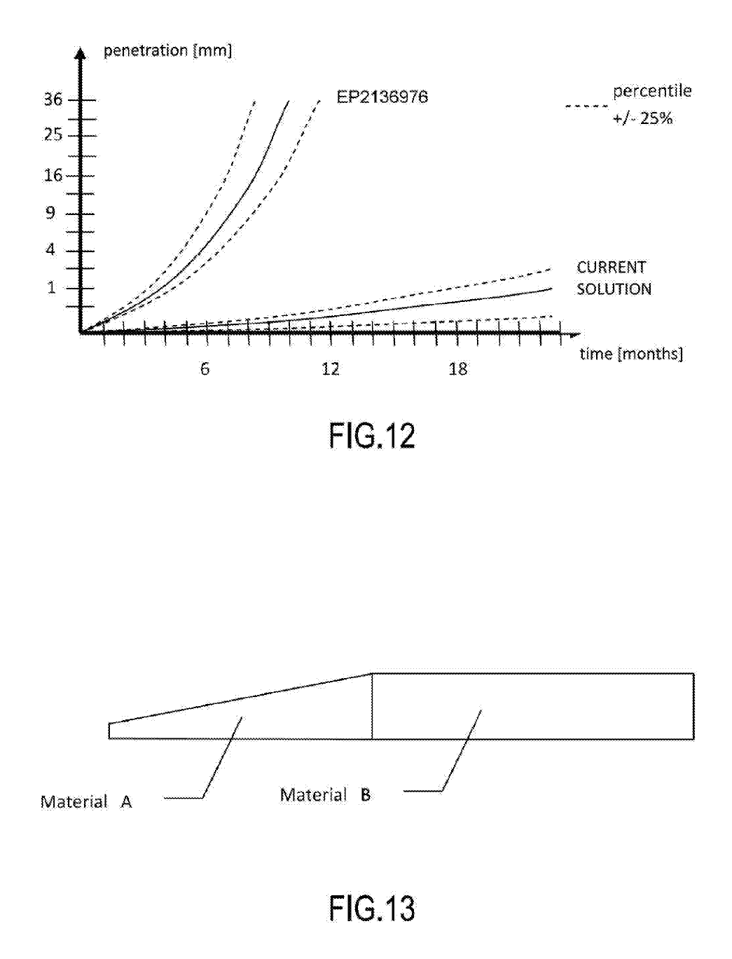

The concepts herein relate to a closing element, of a type adapted to close containers in general and in particular bottles, and a process for making the closing element. In particular the closing element can be a cap for bottles. Caps made of cork are known. Cork caps are used to ensure conservation of liquids, such as alcoholic drinks, for example wine. Caps of known type are made in a single piece of natural cork, or in agglomerated cork, made up of granules of cork held together by an adhesive material, and are also makeable with recycled or waste cork from the production of caps of natural cork. Caps made in a single piece of natural cork have the drawback of having a significant cost, as they can only be made starting from pieces of cork (panels) having sufficient thicknesses, and further have some known problems such as the possible release over time of contaminant substances among which are the so called “red powders” and TCA, which can contaminate the product contained in the bottles. The agglomerated cork has a cost and quality that are lower than natural cork, and is used because of the high cost and insufficient availability of natural cork in amounts that can enable making of caps in a single piece. Caps made of agglomerated cork are however less valuable, also because aesthetically they are less pleasing, and are therefore unsuitable for high-quality products, such as fine wines, and further have very significant percentages of glue. These glues can in some cases in turn contain contaminant substances, and therefore a high presence of the glues can constitute a problem. It is known from patent application EP2136976 (WO2008/113608) a cap can be made by winding a cork sheet. The cap has one or more glue spots, or alternatively a layer of glue distributed only on a limited part of the cork sheet, with the sole objective of keeping the cap compact following the winding of the cork sheet, preventing unwinding thereof. The cap of EP2136976 offers an alternative solution to agglomerated cork caps, as it discloses a cap with a more pleasing appearance with respect to agglomerated caps, notwithstanding a cost which in any case is modest. This wound-sheet cap however has some drawbacks, among which the fact that it does not sufficiently guarantee the quality of the product contained in the bottle. Among the causes of such behaviour is the fact that the cap made according to the teachings of EP2136976 does not have gas seal characteristics, for example to air, that are sufficiently high and constant, and can over time be subject to penetrations, deformations and failure which lead to a decay in the performance of the cap and compromising the quality of the liquid contained (for example due to oxidation of the wine). EP2136976, in FIG. 1 b, illustrates a spotted gluing (1′″), which confirms that the aim of EP2136976 does not consider the insulating aspect between the layers, but considers only 1′″ as the gluing. The problem relating to the penetration of liquids and gases over time is never mentioned in patent EP2136976. An excessive or accelerated penetration of liquids leads to leakages and contamination. This problem can compromise the use of the product constructed according to EP2136976 on the market. The graph illustrated in FIG. 12 shows the results of some tests carried out in the laboratory for comparing the behaviour of products constructed according to EP2136976 and those of products made according to the present patent application. Already after 10 months the products according to EP2136976 demonstrated a penetration of coloured liquid of as much as 40 mm, with leakages from the container (40 mm is the average thickness of a cork cap for wine bottles), and therefore the performance of a cap made according to the teachings of EP2136976 is very different from and worse than those provided by a conventional cork cap in high-quality single-piece cork.

The penetration of gases is comparable to liquid penetration, but is much more rapid and has an even greater effect of deterioration on the contents. The penetration of gases into the containers leads to an excessive oxygenation, oxidation and/or contamination, partially or completely modifying the aspect of the contents (such as colour and clarity) consistency (such as viscosity and effervescence) and the taste-olfactory quality. International standards (ISO 9727-6 standards) require testing the sealing (penetration/leakage of liquid from the container) by applying, to the closing element, a liquid at the pressure of 1.2 bar. No penetration is acceptable. Laboratory tests of products made according to EP2136976 have demonstrated leakages already at 1.1 bar after a few minutes of testing. Thanks to the solution of the present application, it is possible to resist pressures of over 2 bar.

Microscopic analysis has shown that the penetrations take place between the layers of rolled cork. The application of an insulating material according to the present disclosure and variants thereof ensure the necessary mechanical properties and the resistance to penetration of liquids and gases, possibly but not necessarily in combination with a gluing material. Patent EP2136976 does not consider these penetrations and does not suggest any solution or proof that ensures resistance to penetration of the liquids and gases over time. In general, a glue or adhesive material is expressly formulated for gluing surfaces to one another (for example, porous surfaces such as paper, cardboard, cork, etc.) and it is not necessarily a material able to create a barrier or insulating effect (as, for example, are seals, plastic films with barrier effect, etc.). Adhesive materials or glues are not normally used as insulators, hydro-repellents or barriers, as normally these are materials formulated expressly to optimise the gluing or adhesive qualities thereof, and not the insulating qualities thereof, which can also be absent, poor or insufficient for applications of interest. The cap of EP2136976 further has the drawback of being constructed at constant pressure, limiting the variations as a function of the container, of the liquid and the sheet material. A further drawback of EP2136976 is the possibility of peeling of the external rings of the cap during the pressurised bottling, an aspect not considered and under-evaluated in EP2136976. The concepts presented herein resolve one or more of the problems found in the prior art. An aim of the concepts presented herein is to improve the conservation of alcoholic substances such as wines. A further aim of the concepts presented herein is to provide a closing element which prevents deterioration of the contents of the bottles, in particular wine. A further aim of the concepts presented herein is in providing a closing element which provides an excellent seal. Another aim of the concepts presented herein lies in providing a closing element which provides technical characteristics that are constant over time. A further aim of the concepts presented herein is to enable making caps of high quality by using parts of cork normally considered to be of lower quality than the traditional quality or indeed re-evaluating a waste material of the single-piece caps market, or caps used for fizzy wines such as sparkling wines, champagne, etc. . . . . A further aim of the concepts presented herein is to make available a process for making a closing element that is simple, economical and effective, while maintaining the qualitative aspect of a natural single-piece cap. These aims and others besides, which will emerge more clearly from the following description, are substantially attained by a closing element and a process for making a closing element according to what is expressed in one or more of the appended claims and/or the following aspects, taken alone or in any combination with one another or in combination with any one of the appended claims and/or in combination with any one of the further aspects or characteristics described in the following. In an aspect a closing element is provided for containers for liquids, in particular bottles, comprising at least a cork sheet having two main faces opposite one another and further comprising at least a layer of insulating material, increasing the impermeability to liquids and to air and/or gases, coupled to the cork sheet so as to at least partly cover at least one of said two main faces, the cork sheet and the layer of insulating material being rolled so as to define said cap by alternated winding of the cork sheet and the layer of insulating material, wherein the cork sheet comprises various types of cork, for example solid natural cork and agglomerated cork or micro-agglomerated cork and/or wherein a first portion of the cork sheet is made of agglomerated or micro-agglomerated cork and a second portion of the cork sheet is made of solid natural cork. In an aspect, the closing element for containers is a cap for bottles, in particular for wine bottles. In an aspect, the insulating material is deformable and the layer of insulating material is configured for at least partly filling empty spaces and/or for filling surface discontinuities present in the cork sheet or due to the winding method so as to make the cap impermeable to gases and/or air and to liquids or to increase the impermeability thereof to the gases and/or air and to liquids. In an aspect, a quantity of insulating material is used that is able to at least partly fill empty spaces and/or surface discontinuities present on the cork sheet or due to the winding method so as to make the cap impermeable to liquids and to air and/or to gases. In an aspect, the insulating material is organic. In an aspect, the insulating material is inorganic. In an aspect the mechanical winding of the cork sheet is secured by a partial and spotted gluing of the surfaces, preferably only at the external end thereof. In an aspect, the closing of the winding can be done mechanically, for example by sewing or another method. In an aspect, the insulating material is injected at the ends of the winding after carrying out the winding itself. In an aspect, the insulating material is modelled during the rolling step of the cork sheet under rolling pressure. In an aspect, the insulating material is pressed against the cork sheet and is modelled by the action of the pressure. In an aspect any combination of the geometries (for example, but not limited to those geometries denoted by 5A, 5B, 5C, 5D in the figures) can occur with elements processed separately and then joined mechanically or with glues so as to create a single sheet and enabling the following work operations (for example the winding, etc.). A variant of this aspect is illustrated in FIG. 13.

According to further aspects, usable in combination with any one of the claims or the other indicated aspects, the insulator can have one or more of the following characteristics, and be:
a hydro and/or oil repellent product;
a product which prevents problems of infiltration through the natural and not-natural splits in the cork;
a shield that penetrates and is fixed in the micro-porosities of the material, attaining a hydro-repellent effect without altering the chemical-physical and organoleptic characteristics;
a water-repellent impregnating agent;
a sealant;
a hybrid elastic sealant and adhesive;
a cold-applied self-adhesive tape for sealing and impermeabilising over joints and splits;
an organic product or resins according to the production technology used or the desired specificities of the product;
a hydrophilic material;
a microporous but hydro-repellent material which prevents liquids and gases from penetrating internally of the closing element or the container;
comprising biopolymers;
a substance comparable to substances deriving from petrol processing starting from renewable resources; such as for example propanediol, butanediol, adipic acid, succinic acid and ethanol, from which various types of polyester are obtained (for example Poly butylene terephthalate (PBT) and polyethylene;
a biodegradable foam (or comprising a plurality of biodegradable foams), constituted 100% by natural products, starting from PLA (polylactic acid), which can derive, but not only, from plants such as corn, wheat or beetroot, rich in natural sugar (dextrose);
a surface filler;
a film former.

In an aspect, a first portion of the cork sheet destined to constitute a central portion of the closing element, is made of agglomerated or micro-agglomerated cork and a second portion of the cork sheet destined to constitute an external layer of the alternated winding is made of solid natural cork. In an aspect, the closing element has a substantially cylindrical conformation. In an aspect, the height of the closing element is substantially defined by the height of the cork sheet. In an aspect, said layer of insulating material is engaged on both faces of the cork sheet on at least 10% or at least 30% or at least 50% or at least 70% or at least 90% of the surface of each face of the cork sheet. In an aspect, said layer of insulating material is engaged on both faces of the cork sheet substantially over the whole surface of each face of the cork sheet. In an aspect, the closing element comprises a plurality of layers of insulating material. In an aspect, the cork sheet is interposed between two layers of insulating material. In an aspect, the layer of insulating material is impermeable and resistant to alcoholic solutions. In an aspect, an additional layer of glue is applied on at least an end of the layer of insulating material or on the whole surface of the insulating material. In an aspect, the closing element comprises one, two or more additional layers of glue applied on one or both the faces of the cork sheet or on both the layers of the insulating material engaged to the opposite faces of the cork sheet. In an aspect, at least an end of the cork sheet has a constant thickness. In an aspect, at least an end of the cork sheet has a thickness variable between 0.3 mm and 3.5 mm or between 0.5 mm and 3 mm. In an aspect, at least an end of the cork sheet has a thickness that is variable in a parallel direction to the longitudinal extension of the cork sheet perpendicularly to the height of the cork sheet and/or to the height of the closing element. In an aspect, both ends of the cork sheet have a thickness variable between 0.3 mm and 3.5 mm or between 0.5 mm and 3 mm. In an aspect, the cork sheet and the layer of insulating material are wound in a spiral shape. In an aspect, the closing element has a central core orientated in an opposite direction with respect to a main winding direction of the spiral. In an aspect, the closing element has a central core comprising one or more folds of the cork sheet and/or the layer of insulating material. In an aspect, the central folds are reciprocally orientated to form substantially an “S” shape. In an aspect, the closing element comprises a central core about which the cork sheet and the layer of insulating material are rolled, with or without glue. In an aspect, the central core is made of a plastic material. In an aspect, the central core is made of an organic or inorganic material. In an aspect the closing element is defined by a cork sheet and by a sheet of plastic material, reciprocally joined. In an aspect the closing element is defined by a sheet of plastic material constituting a central portion of the closing element and by the cork sheet constituting an external layer of the alternated winding. In an aspect, the closing element has a further layer of insulating and/or adhesive material arranged between the central core and the cork sheet. In an aspect, the closing element has a layer of glue between the central core and the cork sheet. In an aspect, the central core has, according to a transversal section of a longitudinal axis of the closing element, a circular or oval or elliptical conformation, or like conformations at least partly curved. In an aspect, the closing element is made so that the winding and/or pulling pressure of the sheet is controlled, constantly or variably depending on the constructional factors, along the winding diameter of the closing element. In an aspect, the winding and/or pulling pressure of the sheet is variable according to the type of liquid and/or the physical and/or chemical characteristics of the liquid contained in a container, in particular a bottle, to which the closing element is destined to be applied. In an aspect, a use of the closing element is included for closing bottles containing still or sparkling wines. In an aspect a process is included for making a closing element according to one or more of the preceding aspects and/or one or more of the appended claims, comprising:
predisposing a cork sheet having two main faces opposite one another,
applying a layer of insulating material, impermeable to gases and/or to air and to liquids, to the cork sheet so as to at least partly cover at least one of said two main faces of the cork sheet,
rolling the cork sheet, with a controlled pressure, to define said closing element by an alternated winding of the cork sheet and the layer of insulating material, the layer of insulating material and the alternated winding being configured and predisposed to make the closing element impermeable to liquids and air and/or gases;
match and rectify the closing element to the specific dimensions, by eliminating any irregularities or projections.

In an aspect, applying a layer of insulating material comprises spraying, atomising or spreading or applying the insulating material in the form of an adhesive sheet or applying by immersion coating. In an aspect, the process comprises cutting the rolled cork sheet for obtaining a plurality of caps. In an aspect, the cork sheet has a longitudinal extension comprised between 20 mm and 100 mm so as to obtain a single closing element by rolling of the cork sheet, or comprised between 20 mm and 10 m, so as to obtain, by cutting the wound roll of cork, a plurality of caps. In an aspect, the process comprises applying a layer of insulating material on both faces of the cork sheet. There now follows, by way of non-limiting example, a detailed description of one or more preferred embodiments of the concepts herein, in which:

FIG. 1 illustrates a cork sheet to which a layer of insulating material is applied;

FIG. 2 illustrates a closing element according to an embodiment of the concepts herein obtained by rolling the cork sheet and the layer of insulating material of FIG. 1;

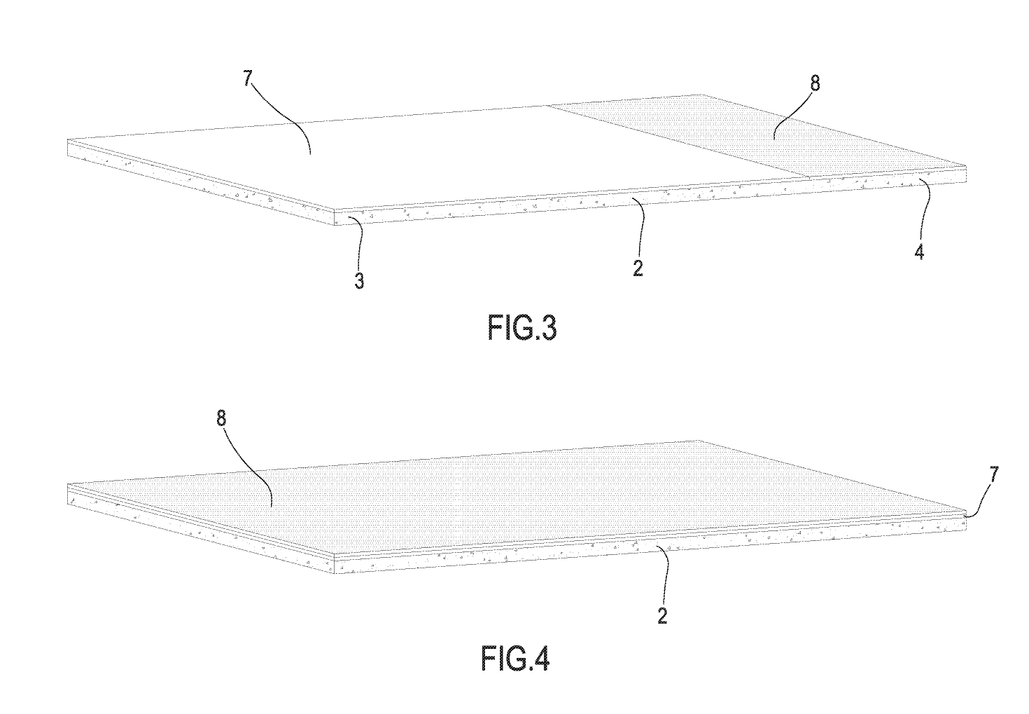

FIGS. 3 and 4 illustrate a cork sheet to which a layer of insulating material and a layer of glue are applied;

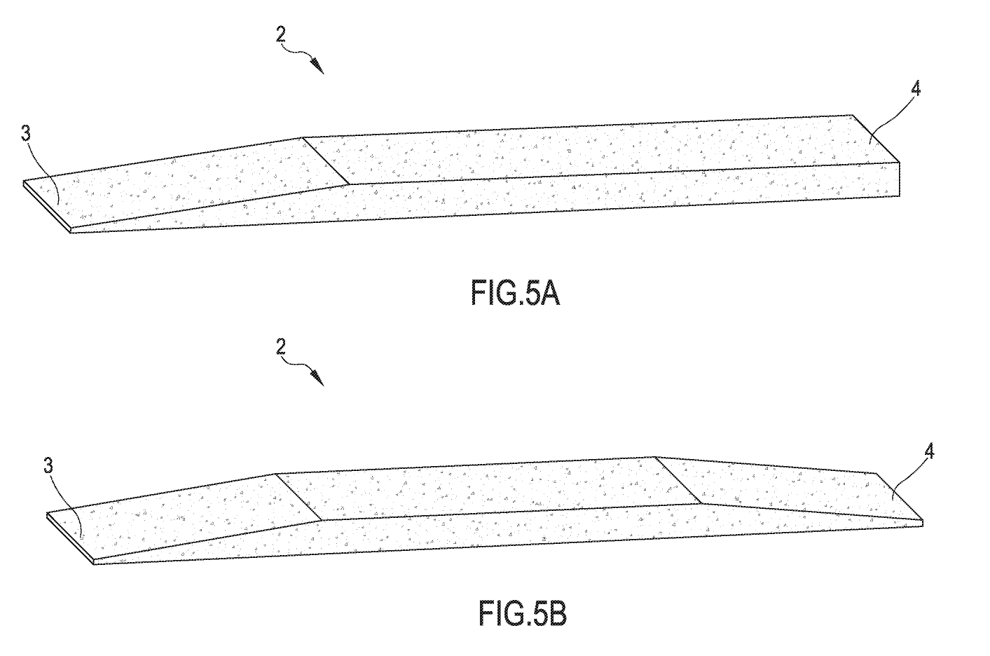

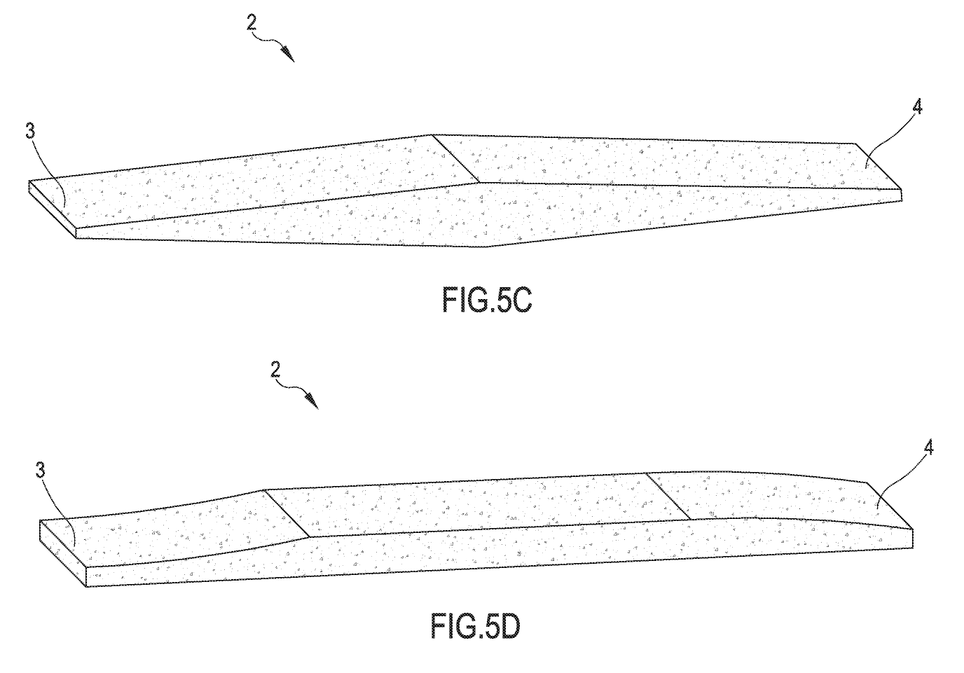

FIGS. 5a, 5b, 5c and 5d illustrate cork sheets having a different progression of the thickness along the longitudinal direction of the cork sheet;

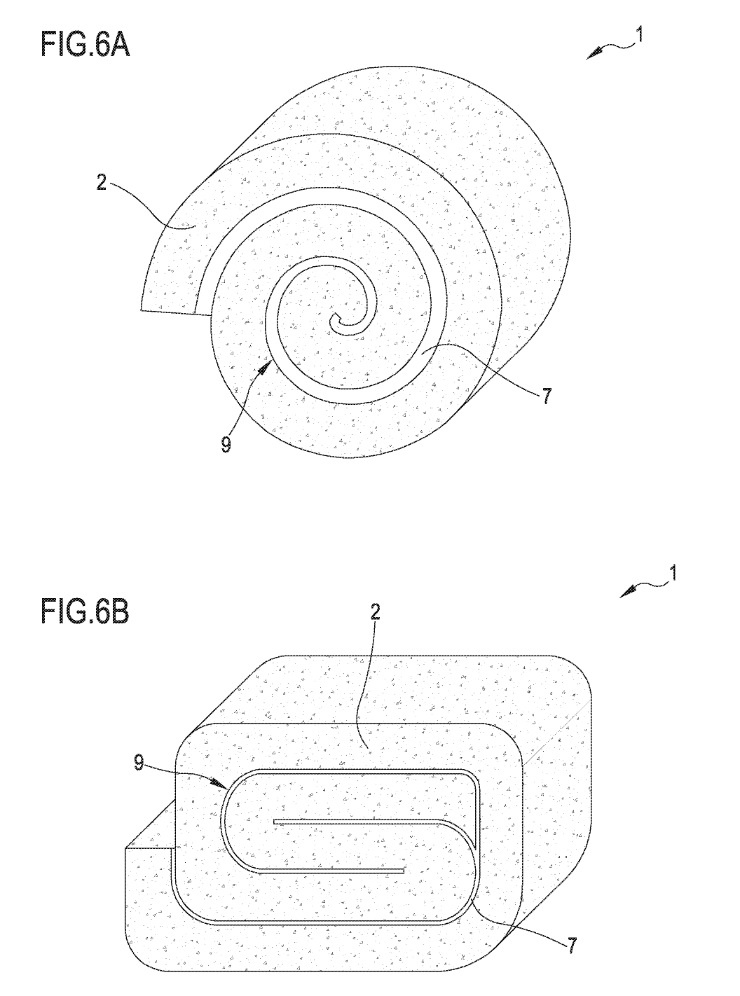

FIGS. 6a and 6b illustrate caps having different cross sections;

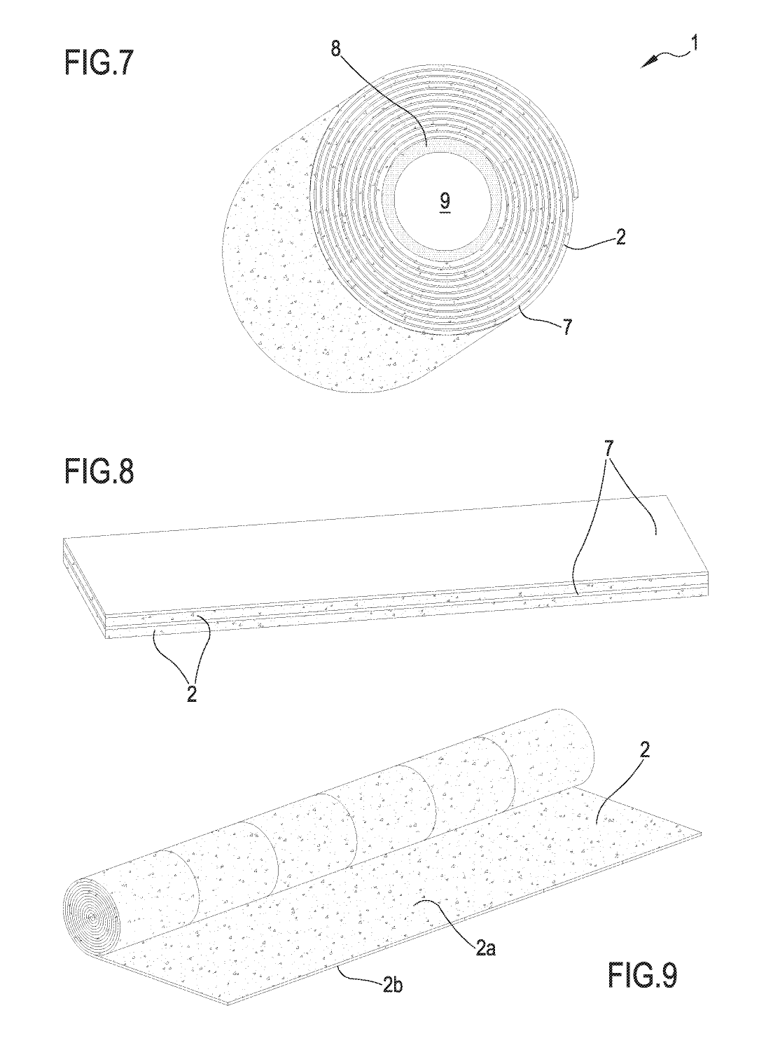

FIG. 7 illustrates a closing element according to an embodiment of the concepts herein;

FIG. 8 illustrates a cork sheet to which a layer of insulating material is applied with or without glue, another layer of cork and another layer of insulating material;

FIG. 9 illustrates a cork sheet rolled starting from which a plurality of caps can be made;

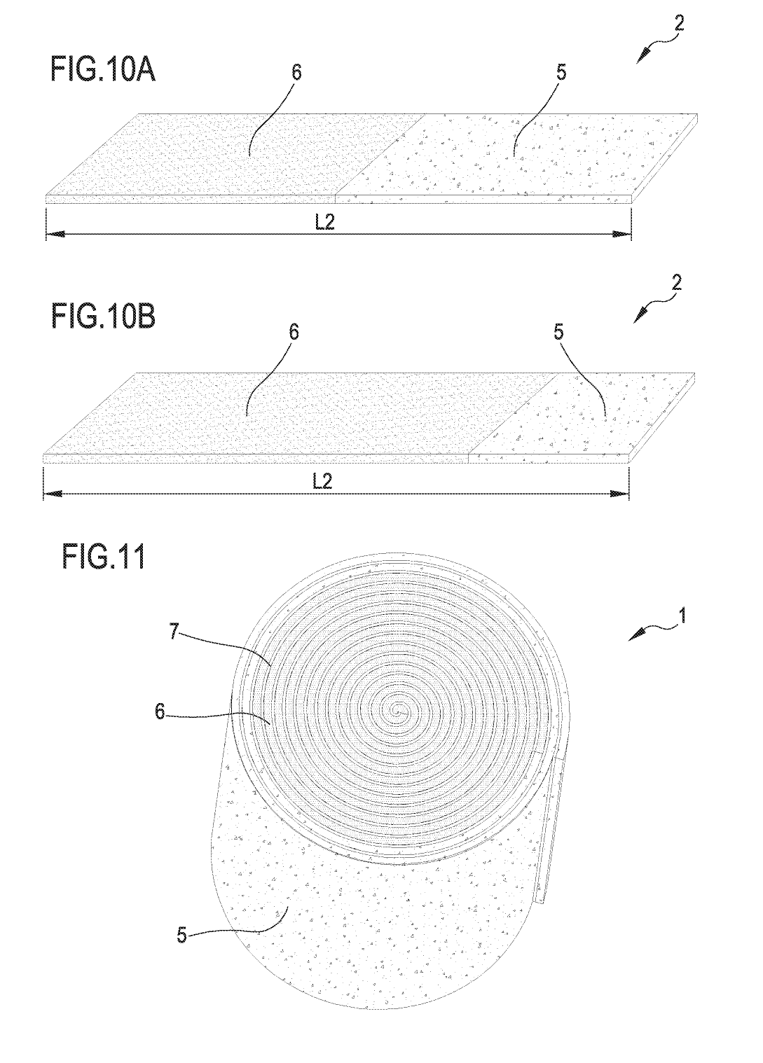

FIGS. 10a and 10b illustrate a cork sheet comprising a first and a second portion in different types of cork;

FIG. 11 illustrates a closing element according to an embodiment of the concepts herein obtained starting from a cork sheet such as the one illustrated in FIG. 10b,

FIG. 12 illustrates a graph relative to comparative tests carried out between the solution of EP2136976 and a solution according to the present application;

FIG. 13 illustrates a further variant embodiment.

With reference to the figures, 1 denotes in its entirety a closing element. The closing element 1 can be constituted by a cap. The closing element is destined to be used for closing containers in general and in particular bottles containing alcoholic substances, but not only. The closing element 1 is particularly suitable for closing bottles of wine, both still and sparkling. The closing element 1 is made by winding one or more cork sheets 2 on themselves to form a roll having a substantially cylindrical conformation (see FIG. 2). The cork sheet 2 has two main faces 2a, 2b opposite one another and extends mainly in a longitudinal direction between a first and a second end 3, 4. The sheet 2 is generally made of natural cork; according to a variant it can be made of agglomerated or micro-agglomerated cork or another organic or inorganic material. According to a variant, the cork sheet 2 comprises various types of cork, for example both agglomerated cork and natural cork, of both superior and inferior quality. As illustrated in FIGS. 10a and 10b, the cork sheet 2 can have a first portion 6 made of agglomerated cork or micro-agglomerated cork, but not only, and a second portion 5 made of natural cork. Both the portions 5, 6 can extend over a longitudinal semi-extension of the cork sheet 2 (FIG. 10a) so as to constitute two parts of the cork sheet 2, the extension of which can be different according to needs and the characteristics of the specific cap. For example, the two portions can be identical, or alternatively, the first portion 6 of the cork sheet 2 can have a longitudinal extension that is smaller than the longitudinal extension of the second portion 5 of the cork sheet (see FIG. 10b). In general, the first portion 6 can be made of a lower quality of cork or in any case having an exterior aspect that is less pleasing than that of the second portion 5. The cork sheet 2 is rolled so that the first portion 6 constitutes an internal portion of the winding of the closing element 1, while the second portion 5 constitutes an external portion of the winding of the closing element 1 (see FIG. 11). In this way, the closing element 1 has a pleasant exterior aspect while not being all made with the same type of cork, with clear savings on production costs. It should be noted that, in general, the cork considered to be less aesthetically pleasing still has, however, excellent and comparable technical qualities (impermeability, elasticity, etc.). The cork sheet 2 has a height H2, defined perpendicularly to the longitudinal extension L2 thereof, which can be comprised between 20 mm and 70 mm or between 30 mm and 70 mm or between 40 mm and 60 mm. Following the rolling of the cork sheet 2, the height H2 of the sheet, taking account of the winding pressure, substantially defines the height of the closing element 1. The cork sheet 2 further has a thickness S2 comprised between 0.3 mm and 3.5 mm or between 0.3 mm and 3 mm. The modest dimensions of the thickness S2 of the cork sheet 2 facilitate the rolling operation of the sheet 2 to define the closing element 1. As illustrated in FIGS. 1, 3 and 4, the cork sheet 2 can have a thickness S2 that is constant along the whole longitudinal extension L2 thereof. Alternatively, the cork sheet 2 can have a thickness S2 variable between 0.3 mm and 3.5 mm or between 0.3 mm and 3 mm at least at an end 3, 4 thereof. The variation of the thickness S2 at an end 3, 4 of the cork sheet 2 advantageously facilitates the rolling of the sheet 2. The thickness S2 of the cork sheet 2 can vary at only one end 3 (see FIG. 5a) or at both ends 3, 4 (see FIGS. 5b and 5d). In the latter variant, proceeding along the longitudinal extension L2 of the cork sheet 2, the thickness S2 varies at the first end 3 from a minimum thickness (for example 0.5 mm) to a maximum thickness (for example 3 mm), is maintained constant for a central portion of the cork sheet 2 and varies again at the second end 4, reducing from the maximum thickness to the minimum thickness. According to a further variant, the thickness can vary over the whole longitudinal extension L2 of the cork sheet 2 (see FIG. 5c). The thickness S2 can vary linearly or not and continuously or not between the minimum thickness and the maximum thickness depending on the application, the material and the sheet, the container and the liquid to be contained. The use of greater thicknesses enables using shorter sheets (length L2), thus enabling using and appreciating high-quality products which at present are thrown away or granulated for the building industry or for agglomerated and/or granulated caps. According to further variants, it is possible to combine the teachings of the solutions of figures from 5a to 5d with the teachings of FIGS. 10a and 10b. For example according to further variants two or more portions can be included, among which a first portion made of a first type of cork (for example agglomerated or micro-agglomerated cork) and a second portion made of a different (or identical) type of cork (for example natural cork), wherein the first (or vice versa the second portion) further has a variable thickness and the second portion (or vice versa the first portion) has a uniform thickness or a variable thickness in a different measure (as illustrated in figures from 5a to 5d). Further, the variation in thickness can take place in one or more directions.

The use of greater thicknesses also reduces the quantity of insulator and/or glue required, bringing further benefits, both financial and in terms of production. As illustrated in FIG. 1, a layer of insulating material 7 is applied to the cork sheet 2. Laboratory testing has demonstrated that the layer of insulating material 7 substantially improves the closing element 1 in terms of impermeability over time against gases and/or air and liquids, such as, in particular, but not only, alcoholic solutions. The layer of insulating material 7 further functions as a barrier for oxygen, preventing it from passing through the closing element 1 and therefore entering into contact with the liquid contained in the bottle, preventing or controlling, if appropriately dimensioned, the oxidation of the liquid. In this way, the closing element 1 prevents deterioration of the liquid contained in the bottle. The insulating material is deformable so as to fill the empty spaces, the porosities and the surface discontinuities of the sheet. The deformation of the insulating material can take place during the rolling of the sheet 2, with the rolling pressure action. According to a variant, the deformation can take place before the pressured rolling of the layer of insulating material 7 on the cork sheet 2, for example by a press. By filling the surface irregularities of the sheet and/or imprecisions in the rolling process, the insulating material fills in the empty spaces in the cork so as to prevent formation of pathways for passage of gases and liquids between consecutive layers of cork in the winding. The insulating material can be of an adhesive type, but not only, and can be hot- or cold-applied. The adhesive insulating material guarantees excellent sealing of the closing element 1 and the compactness of the winding which does not deteriorate and does not tend to fail over time. Further, it substantially improves the seal on the pressurised bottling, ensuring the compactness of the external rings in contact with the container and avoiding peeling during the bottling operation.

In the present description, the term “insulating material” is intended to mean a material having relevant technical characteristics of impermeability to liquids and air and/or gases, able to guarantee a seal of the closing element to those substances that is sufficiently good for a sufficient time, according to the aims of the concepts herein.

In the present description, the term “substantially impermeable” to liquids and air and/or the gases is intended to mean that the element in question substantially prevents the passage of liquids and air and/or gases or which strongly limits the passage so as to guarantee a sufficient seal for the applications of interest, in particular for the closing of wine bottles and/or in a substantially like or similar manner to the degree of impermeability of a single-piece cork cap.

In a variant, the adhesive insulating material can for example be constituted by a glue having properties of impermeability to liquids and air and/or gases and suitable to be used with the cork. According to another variant, the insulating material can instead be of a non-adhesive type. In this case, to guarantee in any case the blocking of the winding of the cork sheet 2 a layer of glue 8 or any other adhesive material can be applied at least at an end 3, 4 (see FIG. 3) of the cork sheet 2; alternatively the blocking could be mechanical (sewing or the like). Alternatively the layer of glue 8 can be applied on an end portion of the layer of insulating material 7 or on the whole surface of the layer of insulating material 7 (see FIG. 4). The insulating material can be applied in various ways to the cork sheet 2. The insulating material can for example be sprayed or atomised on at least a portion of a face 2a, 2b of the cork sheet 2, or on both the faces 2a, 2b of the cork sheet 2. Alternatively, the insulating material can be spread on the cork sheet 2 or applied in the form of an adhesive sheet. It should be noted that an adhesive material or glue is destined to prevent the separation of two surfaces, while an insulating material ensures the impermeability and the impossibility of penetration between the surfaces. An insulator is not necessarily also an adhesive, and vice versa. According to a further alternative, the cork sheet 2 can be immersed in a bath of liquid insulating material; the immersion in the bath can be partial or complete. Alternatively the insulating material can be injected from the ends after the rolling. Obviously also further application modes of the insulating material can be adopted, as a function of the chemical-physical characteristics and the state (solid or liquid) of the insulating material. The insulating material can be applied several times to the cork sheet 2 so as to reach the desired thickness. Regardless of the application mode of the insulating material to the cork sheet 2, the insulating material is applied on at least a face 2a, 2b of the cork sheet 2 on at least 10% or at least 30% or on at least 50% or at least 70% or at least 90% of the surface of the face 2a, 2b or on the whole surface of the face 2a, 2b. The Applicant has found that optimal impermeability results against the gases and/or the air and the liquids have been obtained by applying the insulating material on at least 50% of the surface of a face 2a, 2b of the cork sheet 2. According to an embodiment, the insulating material is applied on both faces 2a, 2b of the cork sheet 2 on at least 10% or at least 30% or at least 50% or at least 70% or at least 90% of the surface of each face 2a, 2b. A further cork sheet 2 can further be applied on the cork sheet 2, at a face 2a, 2b thereof treated with the insulating material so that a layer of insulating material 7 is interposed between two cork sheets 2. As previously mentioned, the use of greater thicknesses, in this case a plurality of sheets, enables using and appreciating high-quality products which at present are thrown away or granulated for the building industry or for agglomerated and/or granulated caps. The layer of insulating material 7 can extend along a band having a height that is at least equal to 10% or at least 30% or at least 50% or at least 70% or at least 90% of the height H2 of the cork sheet 2. The height of the band can further vary or be constant along the longitudinal extension of the cork sheet 2. The band preferably develops without interruption along the whole longitudinal extension L2 of the cork sheet 2. Alternatively, the insulating material can extend along a plurality of bands each having a respective height and arranged on the same face 2a, 2b of the cork sheet 2. Alternatively the insulating material can be spread or applied in another way suitable for the aim and/or can be applied according to various inclinations and/or applied in the form of a net. The sum of the heights of the bands can be at least equal to 10% or at least equal to 30% or at least equal to 50% or at least equal to 70% or at least equal to 90% of the height H2 of the cork sheet 2. The height of the band, or the sum of the height of the bands, can preferably be at least equal to 10 mm or at least equal to 20 mm or at least equal to 30 mm or at least equal to 40 mm or at least equal to 50 mm and in particular can be substantially equal to the height H2 of the cork sheet 2. As illustrated in FIG. 1, the layer of insulating material 7 can extend substantially over all the surface of a face 2a, 2b of the cork sheet 2, i.e. over the whole height H2 and the whole longitudinal extension L2 of the sheet 2. The winding of the cork sheet 2 and the layer of insulating material 7 defining the closing element 1 can have a substantially spiral progression defined on transversal sections at the height of the closing element (see FIG. 2 and FIG. 6a). Alternatively the cork sheet 2 can be folded to define a conformation such as the one illustrated in FIG. 6b, but not only. The cork sheet 2 can be rolled in such a way that a central core 9 of the winding is orientated in an opposite direction with respect to the main winding direction of the spiral or be folded to form an “S” shape, i.e. to form a fold having an opposite folding direction with respect to the folding direction of the remaining folds (FIG. 6b). According to a variant, the central core 9 of the closing element 1 can be made of a plastic material, or any organic compound in the olefin class and the cork sheet 2 can be engaged to the central core 9 by a layer of glue 8 (see FIG. 7). In the following the main steps of the process for manufacturing the closing element will be described. In a first step of the process a cork sheet 2 is predisposed. The cork sheet 2 has one or more of the above-described characteristics and can further have a transversal extension L2 comprised between 20 mm and 10 m. Should the closing element have a longitudinal extension H2 comprised between 20 mm and 70 mm, the process is preferably destined for making a single closing element 1, while in a case where the sheet has a longitudinal extension H2 comprised between 20 mm and 10 m, the process is destined to make a plurality of caps 1. FIG. 9 illustrates for example a cork sheet 2 having large dimensions that can be wound and then cut for making a plurality of caps 1. A layer of insulating material 7 is applied to the cork sheet 2 according to the ways described in the foregoing. In the embodiment in which the insulating material is not adhesive, a layer of glue 8 or any other adhesive material can be applied on the layer of insulating material 7 or directly on a face 2a, 2b of the cork sheet 2 as described in the foregoing or on both faces. At this point the cork sheet 2 and the layer of insulating material 7 are rolled so as to define an alternated winding of cork sheets 2 and layers of insulating material 7 (see FIG. 2). The rolling pressure of the cork sheet 2 determines the deformation of the insulating material which, as is becomes modelled, fills the surface irregularities of the cork sheet 2 so as to substantially improve the impermeabilising capacity of the closing element 1 to the gases and liquids. After having rolled the cork sheet 2 together with the layer of insulating material 7, if the sheet 2 has appropriate dimensions as described in the foregoing, the winding can be cut to make a plurality of caps 1. The concepts herein make it possible to obtain one or more of the following advantages and to resolve one or more of the problems encountered in the prior art. Firstly the concepts herein enable conserving liquids (such as wine) in bottles in a better way and for long period of times. The concepts herein further enable making a resistant closing element, which is not subject to structural failure (peeling, but not only) and which improves its characteristics of being impermeable to gases and liquids over time. The concepts herein further enable preventing contact between the air and in particular the oxygen and the liquid contained in the bottle, in this way preventing the deterioration of the liquid (oxidation but not only). The concepts herein further enable making high-quality caps by the use of even very short cork sheets but having a great thickness, and at present considered less valuable and expensive with respect to the sheets of a suitable thickness for making caps in a single piece, and even by the use of cork sheets and parts which are normally considered waste products, thus reprising this important natural product. The concepts herein further enable eliminating or reducing, thanks to the conformation of the closing element and the layer of coating of insulating material that also functions as a stabiliser, the emission of red powders and other possible contaminants (TCA, but not only) from the closing element toward the product contained in the bottle. The concepts herein further enable avoiding or reducing the use of conventional glues and adhesive materials potentially containing contaminant substances. The concepts herein further make available a process which enables making cork caps simple and at low cost. The concepts herein are moreover convenient to use, easy to implement and simple and economical to make.

1. A closing element for containers for liquids, comprising:
a cork sheet having first and second opposite, principal faces; and
an impermeable layer of insulating material disposed on the cork sheet so as to at least partly cover at least one of said two principal faces, the cork sheet and the layer of insulating material being rolled so as to define said closing element by a winding of alternating layers of the cork sheet and the layer of insulating material;
wherein the alternating layers of said cork sheet and of said layer of insulating material cooperatively engender an overall impermeability of said closing element.

2. The closing element according to claim 1, wherein the overall impermeability of the closing element is substantially equivalent to an overall impermeability of a like cap made solely of cork;
wherein the insulating material is deformable and wherein the layer of insulating material is configured for at least partly filling empty spaces and/or for filling surface discontinuities present in the cork sheet as to provide the overall impermeability; and
wherein the insulating material is sprayed, spread, injected, applied in a form of an adhesive sheet, or applied by immersion coating on the cork sheet,

3. The closing element according to claim 1, wherein the impermeable insulating material is capable of preventing liquid penetration therethrough when inserted into a wine bottle of an amount:
less than 10 mm after a time interval of 12 months; or
less than 5 mm after a time interval of 12 months; or
less than 2 mm after a time interval of 12 months; or
less than 1 mm after a time interval of 12 months; or
less than 10 mm after a time interval of 18 months; or
less than 5 mm after a time interval of 12 months]; or
less than 3 mm after a time interval of 12 months.

4. The closing element according to claim 1, wherein a first turn of winding comprises the layer of insulating material disposed:
only the first principal face of the cork sheet;
on at least 10% of the first principal face of the cork sheet;
on at least 30% of the first principal face of the cork sheet surface;
on at least 50% of the first principal face of the cork sheet;
on at least 70% of the first principal face cork sheet;
on at least 90% of the first principal face of the cork sheet; or
on the entire first principal face of the cork sheet.

5. The closing element according to claim 1, wherein:
the layer of insulating material is made on the cork sheet in a form of at least a band of minimum height of which is at least 10%, at least 30%, at least 50%, at least 70%, or at least 90% of a height of the cork sheet or the height of the closing element; wherein said band extends substantially over a whole longitudinal extension of the cork sheet, perpendicularly to the height of the cork sheet or to the height of the closing element; or
wherein the layer of insulating material is made on the cork sheet in a form of a plurality of bands a sum total of respective heights of said plurality of bands of which at each point of the longitudinal extension of the cork sheet is at least 10%, at least 30%, at least 50%, at least 70%, or at least 90% of a height of the cork sheet or of the height of the closing element, said bands extending on the same face substantially over a whole longitudinal extension of the cork sheet, perpendicularly at the height of the cork sheet or at the height of the closing element; or
wherein the layer of insulating material is made on the cork sheet in a form of at least a band a minimum height of which is at least 10 mm, or at least 20 mm, at least 30 mm, at least 40 mm, or at least 50 mm, said band extending substantially over a whole longitudinal extension of the cork sheet, perpendicularly to a height of the cork sheet or to the height of the closing element; or
wherein the layer of insulating material is made on the cork sheet in a form of a plurality of bands a sum of the respective heights of which is at least 10 mm, at least 20 mm, at least 30 mm, at least 40 mm, or at least 50 mm, said bands extending on the same face substantially over a whole longitudinal extension of the cork sheet, perpendicularly to the height of the cork sheet and/or to the height of the closing element.

6. The closing element according to claim 1, wherein the insulating material is an adhesive or is configured to be hot-applied or cold-applied to the cork sheet.

7. The closing element according to claim 1, wherein the insulating material is non-adhesive.

8. The closing element according to claim 1 wherein the closing element further comprises a layer of glue or adhesive material configured for:
fixing at least an external terminal part of the winding of the cork sheet; or
fixing the winding in a form of a closing element; or
attaching the layer of insulating material to the cork sheet.

9. The closing element according to claim 1, wherein the insulating material is selected from the group consisting of:
an emulsion of a copolymer;
an emulsion of an acrylic copolymer;
an emulsion of a vinyl copolymer;
an emulsion of an acrylic-vinyl copolymer;
a sealant;
a surface filler;
a film former;
an impregnating agent;
a hydro-repellent; and
an oil-repellent.

10. The closing element according to claim 1, wherein the insulating material is non-toxic for food storage.

11. The closing element according to claim 8, wherein the layer of glue or adhesive material is capable of gluing porous surfaces; is of a synthetic type; is of a hot-melt type; or comprises one or more of white hydrogenated hydrocarbon resin; penta-ester resin from erythritol; ethylene vinyl acetate (EVA) copolymer; naphthenic synthetic oil; pharmaceutical grade saturated hydrocarbon oil; or polybutene.

12. The closing element according to claim 1, wherein the cork sheet has a constant thickness between about 0.3 mm and 5 mm, or between about 0.5 mm and about 5 mm; or
wherein the cork sheet has, in at least a portion thereof, a thickness between about 0.3 mm and about 5 mm, or between about 0.5 mm and about 5 mm, the thickness varying in a parallel direction to the longitudinal extension of the cork sheet, perpendicularly to the height of the cork sheet or to the height of the closing element; or
wherein the cork sheet has a thickness that is variable in a parallel direction to the longitudinal extension of the cork sheet, perpendicularly to the height of the cork sheet or to the height of the closing element, the thickness being minimum at least at a first end of the cork sheet that defines the centre of the winding; or at least at a second end of the cork sheet that defines an external layer of the winding, wherein the thickness is maximum at a portion of the sheet distanced from the ends of the sheet that defines a central portion and an external layer of the winding.

13. The closing element according claim 1, having a diameter between about 15 mm and about 40 mm; between about 18 mm and about 36 mm; or between about 22 mm and about 34 mm; or having a height between about 20 mm and about 70 mm, between about 30 mm and about 70 mm or between about 40 mm and about 60 mm.

14. The closing element according to claim 1, wherein the cork sheet is made of a solid natural cork, an agglomerated cork or micro-agglomerated cork or an insulating material; or
wherein the cork sheet comprises a type of cork selected from the group consisting of: natural cork, agglomerated cork and micro-agglomerated cork; or
wherein a first portion of the cork sheet comprises agglomerated or micro-agglomerated cork and a second portion of the cork sheet being attached to the first portion comprises solid natural cork; or
wherein a first portion of the cork sheet defining a central portion of the closing element comprises agglomerated or micro-agglomerated cork, and wherein a second portion of the cork sheet defining an external layer of the winding is made of solid natural cork.

15. A process for making a closing element for bottles, comprising:
providing a cork sheet having two opposite, principal faces;
providing a bilayer by applying an impermeable layer of insulating material to the cork sheet so as to at least partly cover at least one of said two principal faces of the cork sheet; and
rolling the bilayer so as to provide alternating layers of the cork and the insulating material layers;
wherein the insulating material and the cork sheet are configured to make the closing element impermeable to liquids and gases.

16. The closing element of claim 1, wherein said container is a bottle.

17. The closing element of claim 1, wherein said insulating material is impermeable to liquids.

18. The closing element of claim 1, wherein said insulating material is impermeable to gasses and mixtures of different gasses.

19. The closing element of claim 1, wherein said overall impermeability of said closing element is an impermeability to liquids.

20. The closing element of claim 1, wherein said overall impermeability of said closing element is an impermeability to gasses or mixtures of different gasses.
